(19) United States
(12) Patent Application Publication
(10) Pub. No.: US 2024/0127461 A1
(43) Pub. Date: Apr. 18, 2024

(54) METHOD FOR OBTAINING THE VELOCITY FIELD WHEN RESTARTING THE FLOW OF COMPLEX MATERIALS IN A TRANSIENT REGIME

(71) Applicants: PETRÓLEO BRASILEIRO S.A. - PETROBRAS, Rio de Janeiro (BR); UNIVERSIDADE TECNOLÓGICA FEDERAL DO PARANÁ, CURITIBA (BR)

(72) Inventors: MARCIA CRISTINA KHALIL DE OLIVEIRA, RIO DE JANEIRO (BR); YAMID JOSÉ GARCÍA BLANCO, CURITIBA (BR); GUILHERME DOS SANTOS VIEIRA LIMA, RIO DE JANEIRO (BR); EDUARDO MATOS GERMER, CURITIBA (BR); CEZAR OTAVIANO RIBEIRO NEGRAO, CURITIBA (BR); ANGEL DE JESUS RIVERA JIMENEZ, CURITIBA (BR); ADMILSON TEIXEIRA FRANCO, CURITIBA (BR)

(21) Appl. No.: 18/481,104

(22) Filed: Oct. 4, 2023

(30) Foreign Application Priority Data
Oct. 7, 2022 (BR) 10 2022 020462 4

(51) Int. Cl. G06T 7/246; F17D 5/00; G06T 7/215

(52) U.S. Cl. CPC G06T 7/248; F17D 5/00; G06T 7/215

(57) ABSTRACT

The present invention refers to a method for obtaining the velocity field when restarting the flow of complex materials in a transient regime, comprising: defining the number of pairs of images to be obtained; defining the time parameters between pulses and frequency; obtaining and recording a plurality of pairs of images; processing the recorded pairs of images; checking the tracer particle displacement criterion; extracting the first frame of each image from each pair of images; uniting the first frames extracted from each image of each pair of images according to the displacement criterion of the tracer particles, creating new pairs of image frames; calculating the time correction factor between frames of the frames of each of the new pairs of image frames; applying correlation overlap to calculate flow velocity vectors; correlating the images of the new pairs of image frames, using adaptive correlation; obtaining the flow velocity vector map; calculating and applying the correction factor to obtain another vector map; applying a vector statistical function with the corrected velocity; obtaining the flow velocity profile in a transient regime; and obtaining the deformation map in a transient regime.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of Brazilian Application No. BR 10 2022 020462 4, filed 7 Oct. 2022, the entire contents of which are hereby incorporated by reference.

### FIELD OF THE INVENTION

The present invention pertains to the technical field of oil production processes and lifting and flow technologies.

### BACKGROUNDS OF THE INVENTION

Understanding the temporal evolution of the velocity fields of complex fluids upon flow restart becomes increasingly relevant, since these fluids are widely used by various industrial sectors, particularly in the offshore oil industry, where there is the transport of these fluids through pipes.

In the specific case of the flow of paraffin oil through pipelines, the difficulty of analysis arises, as the fluid has a complex behavior caused by the decrease in the solubility of the paraffin crystals, due to heat exchange with the marine environment, and, as a consequence, an increase in its viscosity is evident.

In eventual production stops, the restart of the flow of this fluid implies the transient destructuring of a gelled matrix.

In particular, the process of breaking or destructuring gelled fluids is a particular case, in which transient analysis plays an important role.

It was observed that, when restarting the flow of complex materials, there are steps of destructuring until reaching a fully developed flow, that is, the restart of flow is not direct, but is mediated by intermediate states that evolve as a function of time.

As there is no transient analytical solution for non-Newtonian fluids that allows the temporal analysis of velocity fields, understanding the transient behavior of these fluids is complex, as is the visualization and analysis of the temporal destructuring of the fluid when an external force (pressure drop) is applied.

Currently, in the state of the art, there are methods that involve simulations that require information from reservoirs or devices, which must be installed along the pipes to carry out measurements. The optical methods used in the state of the art, although providing information about the flow, are only implemented in a steady state.

The existing methods in the state of the art do not perform the analysis of the transient flow of Newtonian and non-Newtonian fluids.

Considering the challenges in the transient analysis of flows of complex materials/fluids, there is a need for methods that help the process of understanding the temporal evolution of the velocity fields, in the transient regime.

### STATE OF THE ART

To solve the technical problem of transient flow of non-Newtonian complex materials/fluids, some methods have been reported.

Patent document U.S. Pat. No. 10,961,842B2 presents a method that suggests organizing a series of mechanical cameras arranged throughout the production area and providing a location tracking signal at certain synchronized points in time, wherein the tracking signals are sent to the surface with the fluid. Flow profiles can be estimated from concentration measurements of the different traced materials and can be taken at the surface or at another location downstream.

Furthermore, document U.S. Pat. No. 6,118,519A presents a model that simulates the transient flow of oil from the reservoir to the surface, in fracking extraction processes. The transient model allows determining the composition and properties of the fluids in the well, as well as the pressures in the flow. Furthermore, the transient fluid flow simulator can incorporate several submodels that are coupled together. Specifically, the transient fluid flow simulator can incorporate a well model and a fracture model, making it possible to analyze the flow in the well piping, as well as through the reservoir and/or hydraulic fracture.

Patent document PI0305380-6 performs readings of the flow of a two-phase fluid, in a transient regime, in a detector, by introducing a pulsed tracer particle, at a specific point in the flow in the pipe. At the moment the tracer particle pulse reaches the detection range of the detector, a band of light is introduced by a light source into the flow, generating a signal at the detector. Such a signal can be converted into a graph as a function of time, whose curve is pulse-shaped, to obtain information related to the concentration, degree of dispersion and average size of particles present in the fluid.

Document U.S. Pat. No. 8,527,219A uses a system that has a submerged electric pump, positioned just below the surface of the well, through which the engine will pump a fluid of interest (water, oil or gas, for example). This document provides equations for calculating the transient flow rate (Qw) using data from the piping (cross-sectional area, A), the submerged pump (pressure, Pi, and height from the pump to the fluid surface, h) and the fluid itself (density, ρ). Then, with the result of these equations, it is possible to calculate a transient flow rate as a function of time that can be used to evaluate properties of the fluid in the well.

Furthermore, patent document BR11201200908-9 presents a system similar to that described in document U.S. Pat. No. 8,527,219A with the difference that the processor calculates a relation between efficiency and flow, by applying the voltage and current received in an energy balance equation. The processor obtains a dimensionless flow by applying the relation between efficiency and calculated flow to static data. The processor calculates the flow from that dimensionless number and creates a record of calculated flow rates.

Document U.S. Pat. No. 4,264,330A provides a method that uses tracer particles for undisturbed visualization of fluid flows. This way, it is possible to obtain the flow pattern of an aqueous fluid in pipes. The particles are illuminated by pulses from an ultraviolet laser. Successive frames obtained by an electronic camera from an electronically intensified image of the liquid allow the direction and velocity of particle movement to be monitored as a measure of the fluid flow pattern that is not affected by the presence of the particles.

Another method using an electro-optical system is presented in document U.S. Pat. No. 4,988,191A, which relates to measuring fluid flow velocity and, more particularly, systems in which the fluid flow rate is inferred from measurements made in the context of double-pulse Particle Image Velocimetry (VIP), wherein small scattering particles are illuminated by two short pulses of laser light or other light, and their images are photographically recorded to produce a record from which the particle velocity can be determined by measuring the displacement of the particle images.

Document WO2012051216A1 describes an Echo PIV (Particle Image Velocimetry) process and analysis apparatus developed to reduce noise and analyze DICOM images representing a fluid flow of a plurality of particles. A plurality of DICOM sequential pairs of images are grouped and correlated to create N cross-correlation maps, wherein an average cross-correlation transformation is applied to each cross-correlation map to create a vector map of pair of images for each pair of images; a maximization operation is applied to one or more of the N adjacent vector maps of pair of images to create a modified vector map of pairs of images for one or more of the N pairs of images. The maps are combined to create a corresponding temporary vector map that is calculated to obtain an average velocity vector field of the sequential pairs of images.

Additionally, document U.S. Pat. No. 9,766,265B2 presents a system that, while a sheet of light is generated in a designated region, images of fluid flowing through the designated region are formed at different times. For an inspection region of the plurality of inspection regions defined in the images that has a degree of difference that exceeds a threshold between the local flow velocity vector v(a, b, T) at a given time T and a reference flow velocity vector v(a, b, T±) at times T± that are different from the given time T, the flow velocity vector v(a, b, T) at reference time T is corrected with the reference flow velocity vector v(a, b, T±).

The document by BLANCO, Yamid Jose Garcia. Visualization of viscoplastic fluid flow in an abrupt contraction using particle image velocimetry. 2019. Thesis (Masters in Mechanical and Materials Engineering)—Universidade Tecnológica Federal do Paraná, Curitiba, 2019., addresses to the use of the PIV technique to study a phenomenon in a steady state. Although the PIV technique is used to visualize flow in pipes, the objective is to find magnitudes of turbulence through statistical analysis, where it is necessary for the fluid with non-Newtonian characteristics to reach a fully developed (non-transient) regime.

Furthermore, the document by JIMENEZ, Angel de Jesus Rivera. Restart flow visualization of viscoplastic materials in horizontal tubes using Particle Image Velocimetry. 2021. Thesis (Masters in Mechanical and Materials Engineering)—Universidade Tecnológica Federal do Paraná, Curitiba, 2021, shows how the PIV technique can be used to analyze the flow of non-Newtonian fluids, that is, this document shows how a transient phenomenon can be analyzed with a technique that was created for the analysis of steady-state fluid flows.

Therefore, it is possible to conclude that the state of the art describes methods, systems and experimental units that propose different ways of measuring velocity fields or also volumetric rates of fluid flow through pipes. Therefore, methods are proposed that involve simulations that require information taken from reservoirs or devices that must be installed along the pipes to carry out measurements. The optical methods used, although they provide information about the flow, are only implemented in a steady state.

Thus, there is difficulty in the transient analysis of flows of complex materials, in the process of understanding the temporal evolution of the velocity fields.

Consequently, the present invention presents an analysis method using a Particle Image Velocimetry (VIP) technique, which allows the transient analysis of complex fluids flowing in pipes. Velocity fields and temporal destructuring are analyzed with the method of the present invention, providing relevant information for the analysis of flow restart of complex fluids.

### BRIEF DESCRIPTION OF THE INVENTION

The present invention defines, according to a preferred embodiment, a method for obtaining the velocity field when restarting the flow of complex materials in a transient regime comprising:
defining the number of pairs of images to be obtained;
defining the time parameters between pulses and frequency;
obtaining and recording a plurality of pairs of images;
processing the recorded pairs of images;
checking the tracer particle displacement criterion;
extracting the first frame of each image from each pair of images;
uniting the first frames extracted from each image of each pair of images according to the displacement criterion of the tracer particles, creating new pairs of image frames;
calculating the time correction factor between frames of the frames of each of the new pairs of image frames;
applying correlation overlap to calculate flow velocity vectors;
correlating the images of the new pairs of image frames, using adaptive correlation; obtaining the flow velocity vector map;
calculating and applying the correction factor to obtain another vector map;
applying a vector statistical function with the corrected velocity;
obtaining the flow velocity profile in a transient regime; and
obtaining the deformation map in a transient regime.

The method for obtaining the velocity field when restarting the flow of complex materials in a transient regime, according to the present invention, presents some technical and economic advantages related to:
Determination and visualization of the evolution of velocity profiles, during the restart of flow of non-Newtonian fluids;
Quantitative information on the evolution of velocity and deformation, knowing the value of the velocity and the value at which the material is being sheared;
Qualitative description of the breakdown of the gelled matrix as a function of time, that is, where the destructuring of the material begins and how it occurs;
Correlation of the first derivative of the velocity profile with the restart pressure and quantify the yield stress. The first derivative of the velocity profile is the actual shear rate at which the fluid is sheared and allows the analysis of the fluid's breakdown behavior. Quantifying the yield stress can provide relevant information that can make or break paraffin oil extraction projects;
Reduction in the costs of new projects, particularly in defining the structure of the pipes, which are designed to withstand pressures well above the real ones, due to the lack of knowledge about the conditions for restarting the flow.
Possibility of transient analysis of velocity fields, as well as gel breakdown, can bring advantages in terms of the development of future devices (or processes) that facilitate (reducing the pressure) the restart of flow;
Avoid piping breaking when in operation, protecting the environment and avoiding costs of lost production and costs related to the recovery of the environment affected by any accident;
Adequate design of oil transport lines, avoiding leaks of oil and/or drilling fluids into the marine environment, which could lead to high environmental impacts;
Knowledge of flow restart processes and mastery of operational techniques, bringing greater comfort to the technical staff working in the process and reducing situations of uncertainty in the operation;
In terms of community, the application of knowledge to other products/processes with the same characteristics, in industries in other sectors, such as pharmaceuticals, cosmetics, food and others, can bring benefits to society.

### BRIEF DESCRIPTION OF THE FIGURES

In order to complement the present description and obtain a better understanding of the features of the present invention, and in accordance with a preferred embodiment thereof, in annex, a set of figures is presented, where in an exemplified, although not limiting, manner, there is represented its preferred embodiment.

FIG. 1 illustrates a flowchart of the steps of the method for obtaining the velocity field when restarting the flow of complex materials in a transient regime according to a preferred embodiment of the present invention.

FIG. 2A presents the comparison between the velocity profiles in the transient regime obtained analytically and those obtained and those obtained using the method for obtaining the velocity field when restarting the flow of complex materials in the transient regime with images recorded with the PIV technique using a first Reynolds number value.

FIG. 2B presents the comparison between the velocity profiles in the transient regime obtained analytically and those obtained and those obtained using the method for obtaining the velocity field when restarting the flow of complex materials in the transient regime with images recorded with the PIV technique using a second Reynolds number value.

FIG. 2C presents the comparison between the velocity profiles in the transient regime obtained analytically and those obtained and those obtained using the method for obtaining the velocity field when restarting the flow of complex materials in the transient regime with images recorded with the PIV technique using a third Reynolds number value.

FIG. 3 shows how the velocity profile of a yield stress fluid begins to develop until it reaches steady state.

### DETAILED DESCRIPTION

The method for obtaining the velocity field when restarting the flow of complex materials in a transient regime, according to a preferred embodiment of the present invention, is described in detail, based on the attached figures.

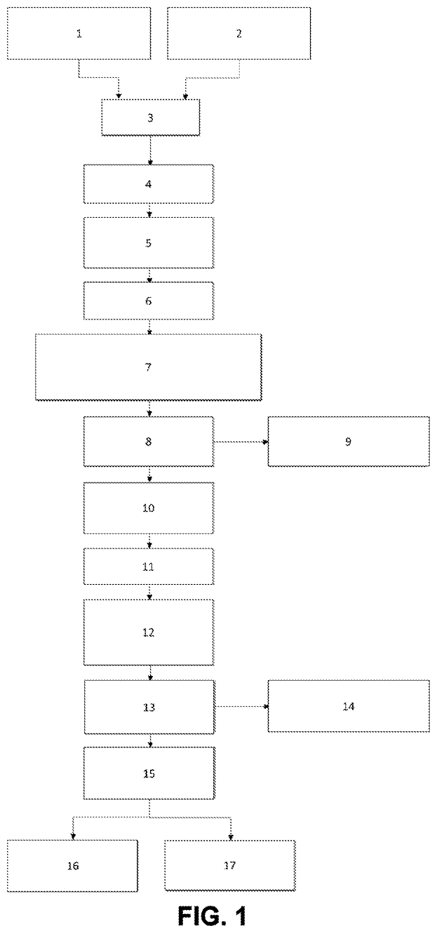

FIG. 1 illustrates a flowchart of the steps of the method for obtaining the velocity field when restarting the flow of complex materials in a transient regime, according to a preferred embodiment of the present invention.

According to FIG. 1, the method for obtaining the velocity field when restarting the flow of complex materials in a transient regime comprises the steps of: defining 1 the number of pairs of images to be obtained; defining 2 the time parameters between pulses and frequency; obtaining and recording 3 a plurality of pairs of images; processing 4 the recorded pairs of images; checking 7 the tracer particle displacement criterion; extracting 8 the first frame of each image from each pair of images; uniting 9 the first frames extracted from each image of each pair of images according to the displacement criterion of the tracer particles, creating new pairs of image frames; calculating 10 the correction factor for the time between frames t′ of the frames of each of the new pairs of image frames; applying correlation overlap 11 to calculate flow velocity vectors; correlating 12 the images of the new pairs of image frames, using adaptive correlation; obtaining 13 the flow velocity vector map; calculating and applying 14 the correction factor t′ to obtain another vector map; applying 15 a vector statistical function that calculates statistical values such as average velocity, standard deviations, variances and covariances of the axial velocity component (U), from the corrected velocity vector maps; obtaining 16 the flow velocity profile in a transient regime; and obtaining 17 the deformation map in a transient regime.

According to a preferred embodiment of the present invention, the images are obtained using the PIV (Particle Image Velocimetry) technique. Furthermore, the number of pairs of images to be obtained can vary between about 500 and about 1000 pairs of images. Furthermore, preferably, each image of the pairs of images obtained using the PIV technique has two frames, wherein these frames represent the image captured at two different instants of time, so that it is possible to correlate the behavior of the particle between these two different instants of time.

According to an additional preferred embodiment of the present invention, the time parameters between pulses and the frequency are defined 2 based on the expected average velocity of the flow, which is calculated for the steady-state condition using the expression for the velocity of a fluid with yield stress, through equation 1; and, in the case of a Newtonian fluid, through equation 2:

$$u = \frac{nR}{( n + 1 )} {( \frac{τ w}{k} )}^{1 / n} [ {( 1 - ϕ )}^{( n + 1 ) / n} - {( \frac{r}{R} - ϕ )}^{( n + 1 ) / n} ] \qquad Equation 1$$

$${u}_{z} ( r , t ) = \frac{{R}^{2} Δ p}{4 μ L} [ 1 - {( \frac{r}{R} )}^{2} ] - {\sum }_{n = 0}^{∞} {C}_{n} {J}_{0} ( {λ}_{n} r ) {ϵ}^{{λ}_{n} t} \qquad Equation 2$$

where Cₙ is expressed as equation 3, below:

$${C}_{n} = \frac{8 {R}^{2}}{{λ}_{n}^{3} {J}_{1} ( {λ}_{n} )} \qquad Equation 3$$

where R is the pipe radius, Δp is the pressure gradient, μ is the dynamic viscosity, L is the pipe length, r/R is the radius ratio, J₀ and J₁ are the Fourier-Bessel functions, λₙ are the eigenvalues and t is the time.

The step of obtaining and recording 3 the pairs of images comprises obtaining and recording 3 the pairs of images using image processing software, which may be software of common knowledge in the technological field in question.

Particularly, according to a preferred embodiment, the step of processing 4 the recorded pairs of images comprises: performing arithmetic operations to improve resolution and eliminate light refractions in images 5, which include: a) calculating the average intensity of the pixels, corresponding in all selected images, considering the particles that present movement, wherein the calculation of the average intensity of the pixels is carried out by assigning a value to the intensity of the light captured by each pixel; b) performing an arithmetic subtraction operation on what is fixed in the image and what is in motion, that is, filtering out the particles that do not show movement and leaving only the particles that show displacement between the interrogation windows; and applying 6 a mask to the images to delimit the area of interest to be correlated, performing the correlations within the visualized area and reducing the error or appearance of spurious vectors (vectors with abnormal behavior).

Specifically, according to a preferred embodiment, checking 7 the tracer particle displacement criterion is performed using the displacement criterion of ¼ of the interrogation window, which has the size of 32×32 pixels. Specifically, checking 7 the tracer particle displacement criterion is performed by measuring the displacement of tracer particles that are added to the fluid prior to measurements. Tracer particle displacement detection is checked by calculating a normalized vector from the particle motion. Equation 4, below, expresses the calculation of this displacement. This leads to obtaining a map of vectors in the correlated domain within the images. As there is a possibility of obtaining spurious vectors, a correlation overlap process is then used to find and replace these spurious vectors by comparing them with neighboring vectors, which allows reducing undesirable behavior in regions where there are physical boundaries, such as the walls of the piping.

$${r}_{0} = \frac{\vert {U}_{0} - {U}_{m} \vert}{{r}_{m} + ε} \qquad Equation 4$$

where U₀ is the displacement of the particle, Uₘ is the average of the displacement of the particle using the neighboring displacements, rₘ is the average residual (the average of the natural variation of the data) of the displacements of the neighboring particles and ε is the minimum level of normalization that has been established at 0.1, that is, ε represents the acceptable level of fluctuation in the particle displacement correlation.

Furthermore, as previously stated, each of the images obtained by the PIV technique has two frames, and these frames represent the image captured at two different instants of time so that it is possible to correlate the behavior of the particle between these two different instants of time. As the restart phenomenon presents a slow flow, the tracer particle must move at least a quarter (¼) of a pixel in a 32×32 pixel window, so that it is possible to obtain a correlation of the position of a particle between two instants of different times.

Especially, according to a preferred embodiment, the step of extracting 8 the first frame of each image is performed, as the displacement of a quarter (¼) of a pixel does not occur in the images. Therefore, it is necessary to extract only the first frame of each image from the pairs of images obtained by the PIV technique, so it is possible to have the minimum displacement between one frame and another. More specifically, the step of extracting 8 the first frame of each image from each pair of images comprises using the method of separating the frames individually, with the aim of obtaining a better observation of the movement of the tracer particle.

More specifically, according to a preferred embodiment, the step of uniting 9 the first frames extracted from each image of each pair of images in accordance with the tracer particle displacement criterion comprises uniting the first frames extracted from each image of each pair of images with the double frame uniting method, creating a double image from two individual frame images. In this sense, each image of each pair of images had two frames, the first frames extracted from each image of each pair of images were united, creating new pairs of image frames, in such a way that the frames of the new pairs of image frames can follow the displacement of the tracer particles, at least, in a quarter (¼) of the interrogation window.

Furthermore, according to a preferred embodiment, due to the union 9 carried out of the first frames of each image of each pair of images, creating new pairs of image frames, it is necessary to perform the calculation 10 of the time correction factor between frames t′ of the frames of each of the new pairs of image frames, that is, between one image and the next one. This correction 10 allows calculating the average displacement of the particle in this time interval. The calculation of the corrected time t′ between frames of the new pairs of image frames is given by the ratio between the time between pulses and the image capture/acquisition frequency, according to equation 5, below. In this way, the new pairs of image frames present the minimum displacement necessary to obtain a correlation of the position of a particle and, then, the images are correlated:

$${t}^{′} = \frac{t}{{T}^{- 1}} \qquad Equation 5$$

where T is the frequency, t is the time between pulses and t′ is the corrected time.

Additionally, according to a preferred embodiment, the correlation overlap for calculating flow velocity vectors is applied 11 based on the movement of particles in the new pairs of image frames obtained in the uniting step 9 of the first frames extracted from each image of each pair of images. In this sense, the step of applying correlation overlap 11 to calculate flow velocity vectors comprises iteratively adjusting the size and shape of the interrogation window, adapting the number of tracer particles with a 50% correlation overlap to obtain the map of flow velocity vectors.

The step of obtaining 13 the flow velocity vector map, according to a preferred embodiment of the present invention, includes the creation of a vector map from the correlations of particle positions, which becomes more uniform as the displacement of particles in the flow increases.

More particularly, due to the fact that a pair of frames of an image have a defined time interval between the same, and as the first frames of each image of each pair of frames have been separated from them and united together into new pairs of image frames, the velocity as a function of time is changed, making it necessary to correct the time between frames for each pair of new pairs of image frames. To this end, a velocity correction factor was determined that, through an arithmetic function, will correct the velocity obtained through the vector map. Consequently, according to a preferred embodiment of the present invention, the step of calculating and applying 14 the correction factor t′ (time between frames) comprises multiplying each velocity vector obtained by the new time t′ between frames. The result of this step of calculating and applying 14 the correction factor t′ is another vector map with the corrected velocity.

In this sense, the other vector map with the corrected velocity can be used to obtain 16 the flow velocity profile in a transient regime.

Additionally, a validation is carried out by comparing the flow velocity profile in a transient regime obtained using the Particle Image Velocimetry (VIP) technique and image processing methodology with the transient analytical solution for a fluid Newtonian.

### Exemplification and Validation

By way of example, the method of the present invention is described through a comparison between the experimental velocity profiles obtained for a Newtonian fluid with the aid of the Particle Image Velocimetry (PIV) technique and compared with the transient analytical solution (Fourier-Bessel) given by equation 2, reproduced again below, to verify whether the method provides reliable information on the temporal evolution of a velocity profile.

$${u}_{z} ( r , t ) = \frac{{R}^{2} Δ p}{4 μ L} [ 1 - {( \frac{r}{R} )}^{2} ] - {\sum }_{n = 0}^{∞} {C}_{n} {J}_{0} ( {λ}_{n} r ) {ϵ}^{{λ}_{n} t} \qquad Equation 2$$

where Cₙ is expressed as equation 3, below:

$${C}_{n} = \frac{8 {R}^{2}}{{λ}_{n}^{3} {J}_{1} ( {λ}_{n} )} \qquad Equation 3$$

where R is the pipe radius, Δp is the pressure gradient, μ is the dynamic viscosity, L is the pipe length, r/R is the radius ratio, J₀ and J₁ are the Fourier-Bessel functions, λₙ are the eigenvalues and t is the time.

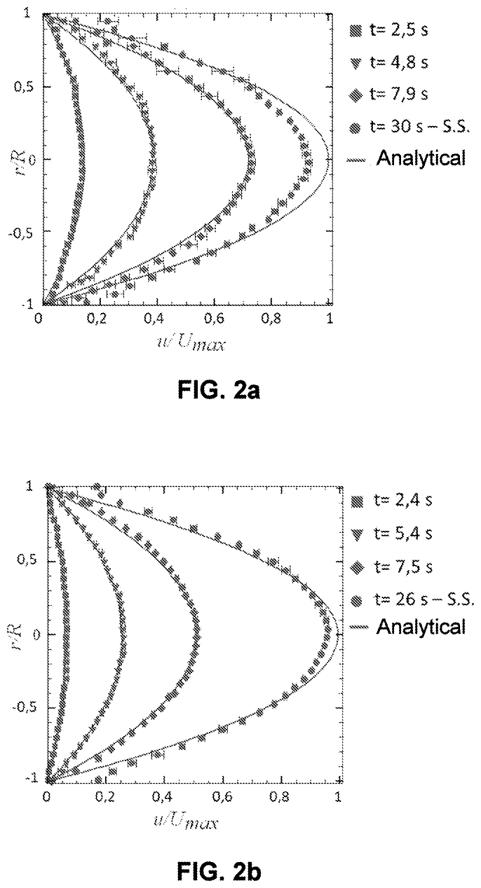

Such a transient analytical solution was used because there is no solution for complex fluids. Furthermore, it is understood that the interest is the method for obtaining the velocity field when restarting the flow of complex materials in a transient regime, being applied to Newtonian or non-Newtonian fluids, that is, the method is independent of the type of fluid used. The results are presented in FIGS. 2A-2C for three values of Reynolds number (Re=1 (a); Re=2 (b) and Re=4 (c)).

FIGS. 2A-C shows the comparison between the velocity profiles in the transient regime analytically obtained (represented in a continuous line, equation 2) and those obtained using the method for obtaining the velocity field when restarting the flow of complex materials in the transient regime with images recorded with the PIV technique (represented by symbols), as presented by the present invention. The analytical and experimental results were obtained for different values of the Reynolds number, Re, and the pressure drop, Δp, using equations 6 and 7, below:

$$Re = \frac{ρ \overline{U} D}{μ} \qquad Equation 6$$

$$Δ p = - \frac{2 L}{r} \cdot μ ( \frac{du}{dr} ) \qquad Equation 7$$

where ρ is the fluid density, Ū is the average velocity, D is the internal diameter of the tube, μ is the absolute (or dynamic) viscosity, L is the pipe length where the pressure drop occurs, r is the radius of the pressure drop region and du/dr is the shear rate.

In this way, it was possible to obtain the profiles to compare the analytical and experimental solution, demonstrating good agreement between the results, with a maximum absolute percentage difference of 6.83% for Re=1. Accordingly, since the method can represent the transient behavior of the Newtonian fluids, it can also be used to analyze other types of materials, since the focus is on the transient phenomenon and not the type of material.

With the validation of the methodology, observed from FIG. 2, the next step is to analyze the temporal evolution of the velocity profile of a complex fluid.

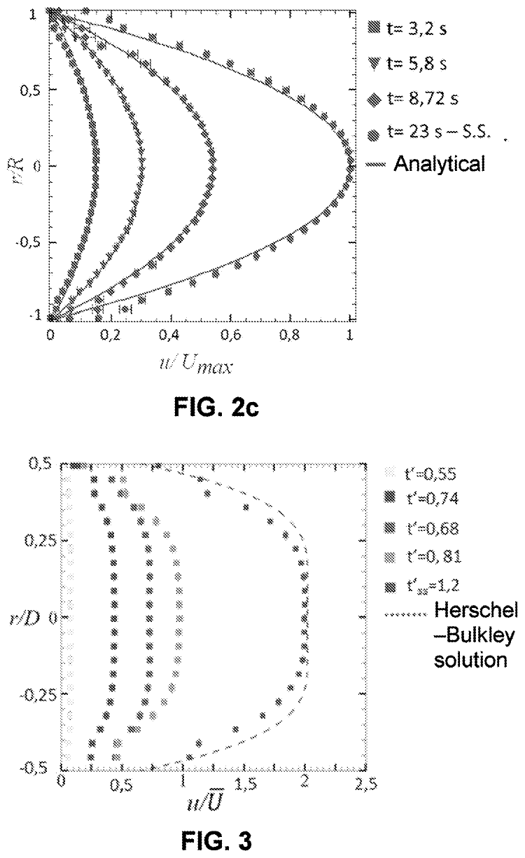

FIG. 3 shows how the velocity profile of a fluid with yield stress (non-Newtonian) begins to develop until it reaches the steady state (represented in dotted line), calculated using the Herschel-Bulkley equation, equation 1, reproduced again below. The absolute percentage difference between the experimental velocity profile (represented by symbols in FIG. 3) and the analytical solution was 4%, reasonably low, demonstrating the efficiency of the PIV technique as a tool for visualizing highly relevant physical phenomena.

$$u = \frac{nR}{( n + 1 )} {( \frac{{τ}_{w}}{k} )}^{1 / n} [ {( 1 - ϕ )}^{( n + 1 ) / n} - {( \frac{r}{R} - ϕ )}^{( n + 1 ) / n} ] \qquad Equation 1$$

where u is the axial velocity, n is the power law index, R is the radius of the pipe, τ_{w} is the shear stress in the pipe wall, k is the consistency index, φ is the ratio between the yield stress and stress of shear on the pipe wall and (r/R) is the radius ratio.

Comparisons with known analytical (mathematical) results of the transient period of the flow also showed an excellent agreement with the data obtained using the experimental methodology, which generates confidence in the obtained data.

As the method has Particle Image Velocimetry as its data source, there is an obvious limitation, which is the use only of translucent fluids, which prevents the use of the technique to analyze the flow of opaque fluids, such as oil or drilling fluid. However, there are fluids whose rheological characteristics can mimic some rheological characteristics of drilling fluids and even oil, and which are translucent, such as carbopol (viscoplasticity), laponite (thixotropy), model oils (oils with the addition of paraffin), between others.

The field in which the invention can be applied, for example, is oil production processes or also in the area of lifting and flow technologies, where the method of the present invention can predict technical information for the process of restarting the flow after interruptions in production. Additionally, the method of the present invention can be applied to the study of restarting gelled drilling fluids after stops in the drilling process.

1. A method for obtaining the velocity field when restarting the flow of complex materials in a transient regime, the method comprising:
defining the number of pairs of images to be obtained;
defining the time parameters between pulses and frequency;
obtaining and recording a plurality of pairs of images;
processing the recorded pairs of images;
checking the tracer particle displacement criterion;
extracting the first frame of each image from each pair of images;
uniting the first frames extracted from each image of each pair of images according to the displacement criterion of the tracer particles, creating new pairs of image frames;
calculating the correction factor for the time between frames (t′) of the frames of each of the new pairs of image frames;
applying correlation overlap to calculate flow velocity vectors;
correlating the images of the new pairs of image frames, using adaptive correlation;
obtaining the flow velocity vector map;
calculating and applying the correction factor (t′) to obtain another vector map;
applying a vector statistical function with the corrected velocity;
obtaining the flow velocity profile in a transient regime; and
obtaining the deformation map in a transient regime.

2. The method according to claim 1, wherein the images are obtained by the Particle Image Velocimetry (PIV) technique.

3. The method according to claim 1, wherein the number of pairs of images to be obtained is 500 to 1000 pairs of images.

4. The method according to claim 1, wherein each image of the pairs of images obtained has two frames.

5. The method according to claim 1, wherein the time parameters between pulses and frequency are defined based on the expected average flow velocity, which is calculated for the steady state condition using the expression for the velocity of a fluid with yield stress, through equation 1; and, in the case of a Newtonian fluid, through equation 2:
$$u = \frac{nR}{( n + 1 )} {( \frac{τ w}{k} )}^{1 / n} [ {( 1 - ϕ )}^{( n + 1 ) / n} - {( \frac{r}{R} - ϕ )}^{( n + 1 ) / n} ] \qquad Equation 1$$
$${u}_{z} ( r , t ) = \frac{{R}^{2} Δ p}{4 μ L} [ 1 - {( \frac{r}{R} )}^{2} ] - {\sum }_{n = 0}^{∞} {C}_{n} {J}_{0} ( {λ}_{n} r ) {ϵ}^{{λ}_{n} t} \qquad Equation 2$$
where Cₙ is expressed as equation 3, below:
$${C}_{n} = \frac{8 {R}^{2}}{{λ}_{n}^{3} {J}_{1} ( {λ}_{n} )} \qquad Equation 3$$
where R is the pipe radius, Δp is the pressure gradient, μ is the dynamic viscosity, L is the pipe length, r/R is the radius ratio, J₀ and J₁ are the Fourier-Bessel functions, λₙ are the eigenvalues and t is the time.

6. The method according to claim 1, wherein the step of processing the recorded pairs of images, comprises: improving the resolution and eliminating light refractions in the images, which include: a) calculation of the average intensity of the corresponding pixels in all selected images, considering the particles that present movement, wherein the calculation of the average intensity of the pixels is carried out by assigning a value to the intensity of the light captured by each pixel; b) performing an arithmetic subtraction operation on what is fixed in the image and what is in motion, that is, filtering out the particles that do not show movement and leaving only the particles that show displacement between the interrogation windows; and applying a mask to the images to delimit the area of interest to be correlated, performing the correlations within the visualized area and reducing the error or appearance of spurious vectors.

7. The method according to claim 1, wherein the checking the tracer particle displacement criterion is carried out using the displacement criterion of ¼ of the interrogation window, which has the size of 32×32 pixels.

8. The method according to claim 1, wherein checking the tracer particle displacement criterion is carried out by measuring the displacement of tracer particles that are added to the fluid before measurements, wherein the displacement of the tracer particle is calculated using equation 4:
$${r}_{0} = \frac{\vert {U}_{0} - {U}_{m} \vert}{{r}_{m} + ε} \qquad Equation 4$$
where U₀ is the displacement of the particle, Uₘ is the average of the displacement of the particle using the neighboring displacements, τₘ is the average residual (the average of the natural variation of the data) of the displacements of the neighboring particles and ε is the minimum level of normalization that has been established at 0.1, that is, ε represents the acceptable level of fluctuation in the particle displacement correlation.

9. The method according to claim 1, characterized in that the correction factor for the time between frames (t′) is given according to equation 5, below:
$${t}^{′} = \frac{t}{{T}^{- 1}} \qquad equation 5$$
where T is the frequency, t is the time between pulses and t′ is the corrected time.

10. The method according to claim 1, characterized in that the correlation overlap for calculating flow velocity vectors is applied based on the movement of particles in the new pairs of image frames obtained in the uniting step of the first frames extracted from each image of each pair of images.

11. The method according to claim 1, wherein applying correlation overlap to calculate flow velocity vectors comprises iteratively adjusting the size and shape of the interrogation window, adapting the number of tracer particles with a 50% correlation overlap to obtain the flow velocity vector map.

12. The method according to claim 1, wherein obtaining the flow velocity vector map includes the creation of a vector map from the correlations of the particle positions.

13. The method according to claim 1, wherein calculating and applying the correction factor (t′) to obtain another vector map comprises multiplying each velocity vector obtained by the new time (t′) between frames, obtaining another vector map with the corrected velocity.
